(19) United States
(12) Patent Application Publication
(10) Pub. No.: US 2025/0346223 A1
(43) Pub. Date: Nov. 13, 2025

(54) VEHICULAR SENSING SYSTEM WITH HEIGHT DETECTION AND OBJECT TRACKING

(71) Applicant: Magna Electronics Inc., Auburn Hills, MI (US)

(72) Inventors: Jason R. Zalev, Thornhill (CA); Nikhil Gupta, Brampton (CA); James W. Reynolds, III, Lapeer, MI (US); Jonathan Paisley, Metamora, MI (US); Patrick J. Tan, Brampton (CA); Guruprasad Mani Iyer Shankaranarayanan, Mississauga (CA); Alexander Velichko, Toronto (CA); Sai Hemanth Reddy Pingali, Novi, MI (US)

(21) Appl. No.: 19/201,978

(22) Filed: May 8, 2025

Related U.S. Application Data
(60) Provisional application No. 63/644,717, filed on May 9, 2024.

(51) Int. Cl. B60W 30/09; B60W 30/095; B60W 50/14; G01S 13/931; G01S 15/931; G01S 17/931; G06T 7/62; G06V 20/56

(52) U.S. Cl. CPC B60W 30/09; B60W 30/0953; B60W 50/14; G01S 13/931; G01S 15/931; G01S 17/931; G06T 7/62; G06V 20/56

(57) ABSTRACT

A vehicular sensing system includes a sensor disposed at a vehicle and sensing exterior of the equipped vehicle. The sensor is operable to capture sensor data. The vehicular sensing system, via processing the sensor data, determines two-dimensional (2D) points each associated with an object and determines width of the object based on a spatial distribution of a subset of the 2D points associated with the object. The vehicular sensing system determines height of the object based on (i) 2D points associated with the object and (ii) the determined width. The vehicular sensing system, based on movement of the equipped vehicle relative to the object, determines whether the object is within a path of travel of the equipped vehicle. Responsive to (i) the object being within the path of travel and (ii) the determined height of the object exceeding a height threshold, the vehicle is maneuvered to avoid the object.

### CROSS REFERENCE TO RELATED APPLICATION

The present application claims the filing benefits of U.S. provisional application Ser. No. 63/644,717, filed May 9, 2024, which is hereby incorporated herein by reference in its entirety.

### FIELD OF THE INVENTION

The present invention relates generally to a vehicle sensing system for a vehicle and, more particularly, to a vehicle sensing system that utilizes one or more ultrasonic sensors at a vehicle.

### BACKGROUND OF THE INVENTION

Use of sensors in vehicle sensing systems is common and known. Examples of such known systems are described in U.S. Pat. Nos. 9,146,898; 8,027,029 and/or 8,013,780, which are hereby incorporated herein by reference in their entireties.

### SUMMARY OF THE INVENTION

A vehicular sensing system includes a sensor disposed at a vehicle equipped with the vehicular sensing system. The sensor senses exterior of the equipped vehicle and is operable to capture sensor data. The vehicular sensing system includes an electronic control unit (ECU) including electronic circuitry and associated software. The electronic circuitry of the ECU includes a data processor operable to process the sensor data captured by the sensor and transferred to the ECU. With the vehicle moving relative to an object exterior of the equipped vehicle, the vehicular sensing system, via processing at the ECU of the sensor data captured by the sensor, determines two-dimensional (2D) points associated with the object. Each 2D point corresponds to a respective location on the object. The vehicular sensing system determines a width of the object based at least in part on a spatial distribution of a subset of the 2D points associated with the object as the vehicle moves relative to the object. The vehicular sensing system determines a height of the object based at least in part on (i) 2D points associated with the object and (ii) the determined width of the object. The vehicular sensing system determines whether the object is within a path of travel of the equipped vehicle based at least in part on movement of the equipped vehicle relative to the object. Responsive to (i) the object being within the path of travel of the equipped vehicle and (ii) the determined height of the object exceeding a height threshold, the vehicle is maneuvered to avoid the object.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a sensing system that incorporates ultrasonic sensors;

FIG. 2 is a flowchart of an example arrangement of operations for instructing a vehicle to maneuver based on a determined height of an object;

FIGS. 3A and 3B illustrate a list of two-dimensional points in local vehicle coordinates within a region of interest;

FIGS. 4A and 4B are flowcharts of an example arrangement of operations for determining a height of an object;

FIG. 5 is a flowchart of an example arrangement of operations for determining a height of an object using a first and second pass;

FIG. 6 is a flowchart of an example arrangement of operations for performing the first pass from FIG. 5;

FIG. 7 is a flowchart of an example arrangement of operations for performing the second pass from FIG. 5;

FIGS. 8A and 8B are flowcharts of an example arrangement of operations for determining a width of an object;

FIG. 9 is a flowchart of an example arrangement of operations for determining whether a filled window bin conditioned is satisfied from FIGS. 8A and 8B;

FIG. 10 is a flowchart of an example arrangement of operations for determining whether an unlatching condition is satisfied from FIG. 8A; and

FIG. 11 is a flowchart of an example arrangement of operations for determining whether wide latch condition is satisfied from FIG. 8A.

### DESCRIPTION OF THE PREFERRED EMBODIMENTS

A vehicle sensing system and/or driver or driving assist system and/or object detection system and/or alert system operates to capture sensing data exterior of the vehicle and may process the captured data to detect objects at or near the vehicle and in the predicted path of the vehicle, such as to assist a driver of the vehicle in maneuvering the vehicle in a forward or rearward direction. The system includes a processor that is operable to receive sensing data from one or more sensors and provide an output, such as an alert or control of a vehicle system.

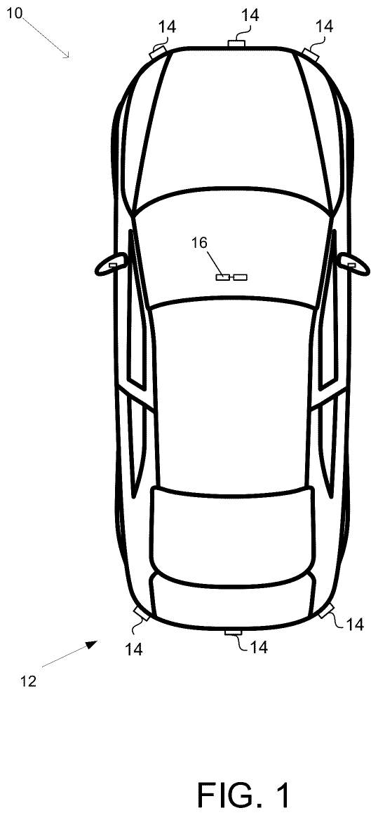

Referring now to the drawings and the illustrative embodiments depicted therein, a vehicle 10 (FIG. 1) includes a driving assistance system or sensing system 12 that includes at least one ultrasonic sensor 14, such as one or more forward facing ultrasonic sensors 14 and/or one or more rear facing ultrasonic sensors, which sense regions exterior of the vehicle. Alternatively, the sensing system may include multiple other sensors, such as cameras or image sensors, radar, sensors, lidar, etc., that sense the regions exterior of the vehicle. The sensing system 12 includes a control or electronic control unit (ECU) 16 that includes a data processor that is operable to process data captured by the ultrasonic sensor(s). The ECU or processor is operable to process the received or captured sensor data captured by the ultrasonic sensors 14 to sense or detect objects exterior of the vehicle 10. The ECU or sensing system 12 may be part of a driving assist system of the vehicle, with the driving assist system controlling at least one function of the vehicle (such as to provide autonomous driving control of the vehicle) responsive to processing of the data captured by the ultrasonic sensors 14 (e.g., steering, braking, or otherwise maneuvering the vehicle). The data transfer or signal communication from the sensor to the ECU may include any suitable data or communication link, such as a vehicle network bus or the like of the equipped vehicle.

A collision by a vehicle with an object that has a low height (e.g., a curb, a small bump, a pothole, a small box, etc.) is typically less severe than a collision by the vehicle with an object that has a higher height (e.g., another vehicle, a pole, a pedestrian, etc.) where a greater safety concern arises. For this reason, determining the height of objects surrounding the vehicle and instructing the vehicle to maneuver based on the determined height of the objects can improve performance and safety of vehicle safety systems.

However, some ultrasonic sensor configurations are unable to distinguish between objects with a low height from objects with a high height using conventional pulse echo localization techniques. This lack of distinguishing objects with low heights (e.g., less than a predetermined height threshold) from objects with high heights (e.g., exceeding the height threshold) is often due to the configured physical geometry of a sensor array. For example, if all sensors in an array are substantially coplanar (e.g., each sensor is positioned at substantially the same distance vertically off the ground) or substantially collinear (e.g., aligned along a single line), then the height of objects becomes ambiguous. This ambiguity arises because the sensors lack sufficient vertical separation to provide a baseline for accurately resolving the vertical position (e.g., height) of the detected objects. Consequently, vehicle sensing systems cannot resolve or determine the height of objects accurately.

Typically, localization of acoustically reflective targets is performed by transmitting an ultrasonic pulse using an ultrasonic sensor and receiving ultrasonic signals including echoes of the pulse using the same and/or other ultrasonic sensors. However, other sensors, such as radar sensors, cameras or image sensors, and/or lidar sensors, may also be used. The locations of reflected targets are solved using measured echo delay times, known sensor positions, and a known speed of sound. Localizing a position of an acoustic target using echoes from at least two different known sensor positions is known as “triangulation.” Strong echoes can be detected in received ultrasonic signals by performing “peak detection” on the amplitude of an ultrasonic signal (or the amplitude of the envelope of the ultrasonic signal). The accuracy of triangulation depends on various factors including geometry and the nature of acoustic reflections from various acoustically reflective targets (e.g., objects exterior of the vehicle) in various environmental circumstances.

A “sensor firing event” corresponds to one or more sensors transmitting an ultrasonic pulse followed by one or more ultrasonic sensors receiving ultrasonic signals due to the transmitted pulse. In some examples, the vehicle sensing system produces a list of echoes corresponding to detected peaks received from each sensor for each sensor firing event.

In some implementations, the vehicle sensing system computes a two-dimensional (2D) point using triangulation for each pair of peak detected echoes from adjacent sensors. A 2D point corresponds to the expected or predicted position of a part or point in two-dimensional space of an object (e.g., distance to the point or object and lateral position of the point or object) located exterior of the vehicle. For example, using sensor array data of a vehicle, an earliest peak-detected echo from one sensor can be triangulated with an earliest peak-detected echo from an adjacent sensor thereby yielding the position of an acoustically reflective target exterior to the vehicle. Put another way, the vehicle sensing system may determine the position of an obstacle exterior of the vehicle using a first echo received at a first sensor and a second echo received at a second sensor. Here, the first and second sensors are located adjacent to one another and the first echo and the second echo are presumed to be reflected from the same object and may be received at substantially the same time. In some examples, a target represents an obstacle or an object located exterior of the vehicle.

In general, acoustically reflected echoes behave in different ways for acoustic targets with different geometries. For example, large reflective targets, such as the surface of a vehicle or a wall, may produce a first echo that reverberates and/or reflects followed by a subsequent second reflection that causes a second echo to be detected by the sensor. When this occurs, the second-received echo has approximately double the travel time as the first-received echo. In contrast, low profile objects and/or narrow profile objects may not produce secondary echoes.

Echoes and their detected peaks have additional properties that can be determined from received ultrasonic signals, which are impacted by acoustic target geometries. For example, the waveform associated with an echo peak has an “echo width,” corresponding to the time duration (or distance) over which the signal amplitude remains above a threshold level surrounding each peak. In addition, each echo peak is associated with an “echo strength” corresponding to the amplitude of a detected peak. The timing of a detected peak, the “echo distance,” corresponds to the distance of a target from sensors. The “echo distance ratio,” represents a ratio of the echo distance between an earliest echo peak and a later echo peak detected in a received ultrasonic signal and can be used to predict if a reverberation from a target has occurred, in which case the latter echo should have approximately double the travel time as the earlier echo. Another echo property is the “echo distance difference” that represents the difference in echo distance between an earliest echo peak and a later echo peak of a received ultrasonic signal, signifying how close the two peaks are to each other.

Thus, echo properties include information correlated with the geometry of acoustic targets (e.g., geometry of objects exterior of the vehicle). As such, echo properties such as “echo width,” echo strength,” “echo distance,” “echo distance ratio,” and “echo distance difference” may be used to infer geometric information about an acoustic target. For instance, the vehicle sensing system may determine a position, size, shape, etc. of a particular object based on the echo properties of one or more received echoes.

In some implementations, machine learning (ML) classification models are trained to extract or determine a “height score” from echo properties of a received ultrasonic signal that is correlated with the height of an acoustic target. Training involves collecting labeled training data that includes ultrasonic signals from multiple categories of objects (e.g., multiple different “high” objects and “low” objects) and feeding a corresponding list of echo properties to a machine learning classifier, such as a binary classifier. Each training ultrasonic signal is paired with a ground-truth label indicating whether the object actually corresponds to a high object (e.g., object that exceeds a height threshold) or a low object (e.g., object that fails to exceed the height threshold). For example, a decision tree or a decision forest can be trained to predict if a set of echo properties extracted from an ultrasonic signal belongs to a high object or a low object. A classifier can also compute the probability that an object belongs to a high classification or a low classification. Additionally or alternatively, the classifier may determine a probable height of an object. Once trained, the classifier operates during inference yielding an efficiently computable function that can be implemented in software, which produces a resulting height score from a set of echo properties.

In some implementations, the amplitude of a received ultrasonic signal is modified by signal processing which may include gain compensation, filtering, time-dependent gain compensation, envelope detection, demodulation, and/or other pre-processing. This processing may impact the echo properties. Other acoustic and environmental factors also impact echo properties, such as air temperature, sensor temperature, air pressure, humidity, altitude, sensor variations, environmental noise sources, and solar radiation. These acoustic and environmental factors may cause changes to sensor heating, sensor height, sensor angle, spacing between sensors, material and surface properties of acoustic targets, and geometries of targets and sensors. The system may include mechanisms to compensate for some of these variations, such as using temperature sensors to adjust the assumed speed of sound.

In some implementations, the vehicle sensing system determines a height score by analyzing a set of echo properties from sensor data. The height score is assigned to a 2D point associated with localization of an obstacle's position determined from echoes. In some examples, the height score is associated with each 2D point from the list of 2D points of the potential obstacles. The height score of a triangulated 2D point may correspond to the height score of the most recent ultrasonic signal that resulted in triangulation proximate to the 2D point. In other words, the height score of a 2D point (e.g., in spatial domain) can be derived from height scores of ultrasonic signals (e.g., in time domain) associated with the 2D point.

When echo triangulation results in a coordinate near a previously detected obstacle (for example, within a predefined proximity, such as a 10 cm rectangular region surrounding an existing 2D point), this corresponds to a “point matching” event which is referred to as “redetection.” When no existing point is located proximate to a newly triangulated position (i.e., no redetection occurs), this is referred to as “first detection.” The “age” of a point corresponds to the number of sensor firing events since its first detection. The “cruising” duration of a point corresponds to the number of sensing firing events since its most recent detection. That is, a point redetection causes resetting of its cursing counter. Alternatively, an elapsed time may be used in place of a count of sensor firing events, which is equivalent up to a proportionality factor when sensor firing events occur at a regular interval (for example, a sensor firing repetition rate of 40 ms). The “confidence” of a point corresponds to the probability that it exists (e.g., probability that the point corresponds to an actual object), which is updated based on continual measurements. The point confidence decays if a point is not redetected and increased when a point is redetected. A point is deleted after its confidence drops below a threshold, or it is no longer considered relevant.

As described above, the geometry of an acoustic target or obstacle impacts its echo properties. As such, using a classifier to distinguish high obstacles from low obstacles may be more accurate for obstacles having a wide spatial extent (for example, objects with a horizontal width available for acoustic reflections larger than a certain value, e.g., 1 m). Thus, classification of narrow obstacles from echo properties alone may be less accurate. To that end, combining echo property classification with analyzing geometric statistics of the distribution of triangulated obstacle positions leads to more accurate height classification based on detected ultrasonic echoes.

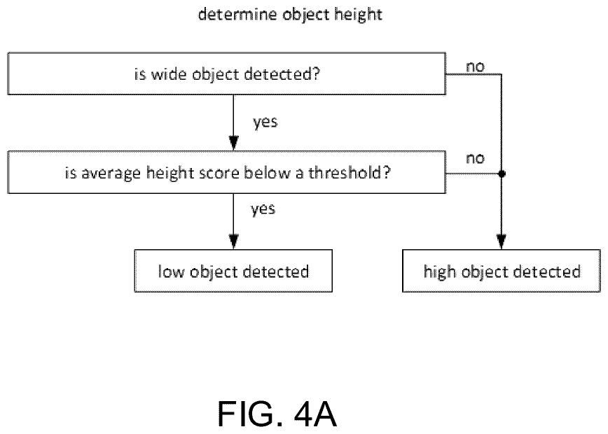

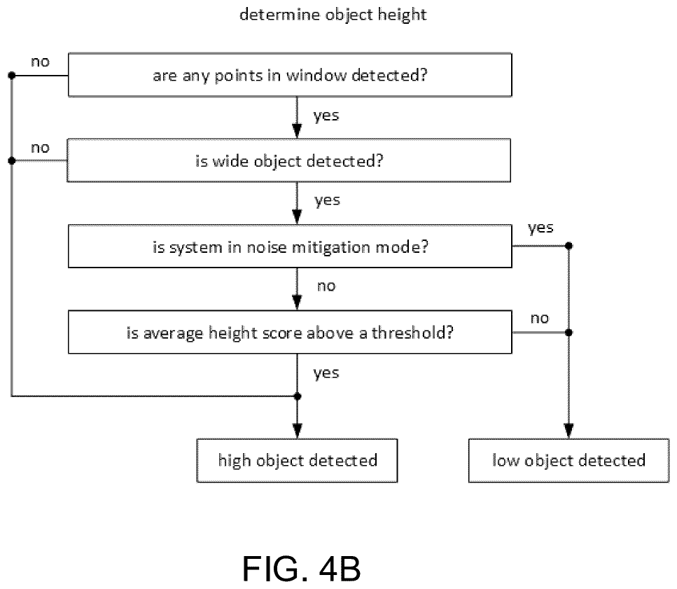

In some implementations, the vehicle sensing system determines or classifies whether a detected object is a low object or a high object based on the sensor data. Here, sensor data may refer to the properties derived from reflected ultrasonic echoes received at one or more ultrasonic sensors. More specifically, the vehicle sensing system may process the sensor data to detect one or more objects exterior of the vehicle and determine, for each detected object, whether the object is a high object or a low object. For instance, as illustrated in the flowchart of FIG. 4A, if a wide object is not detected (e.g., a width of the object is less than a width threshold), then the vehicle sensing system may classify or assume the object is a high object. For example, skinny vertical objects (e.g., objects with a width less than the width threshold) tend to have greater heights, such as a telephone pole. Thus, the vehicle sensing system may assume that objects whose detected point distribution suggests a width that fails to satisfy the width threshold may be presumed to exceed a height threshold. This presumption acts as a safety measure when height cannot be reliably determined from echo properties or triangulation alone for narrow objects. Alternatively, as shown in FIG. 4B, the system may consider if points are detected in a window, whether a wide object is detected, and whether a noise mitigation mode is active before determining the height classification based on the average height score.

Otherwise, if a wide object is detected (e.g., the calculated width meets or exceeds the width threshold), the vehicle sensing system does not make any presumptions about the height of the object and instead relies on the height score analysis to predict the height of the wide object (as shown in FIGS. 4A and 4B). That is, the vehicle sensing system determines height scores associated with triangulated 2D points corresponding to the object and averages each of the height scores of the object to determine the height classification of the object. In some examples, the vehicle sensing system classifies the detected object based on whether the average of height scores exceeds a height threshold. The average may be the arithmetic mean, a weighted average, or another function that consolidates the height scores associated with the object.

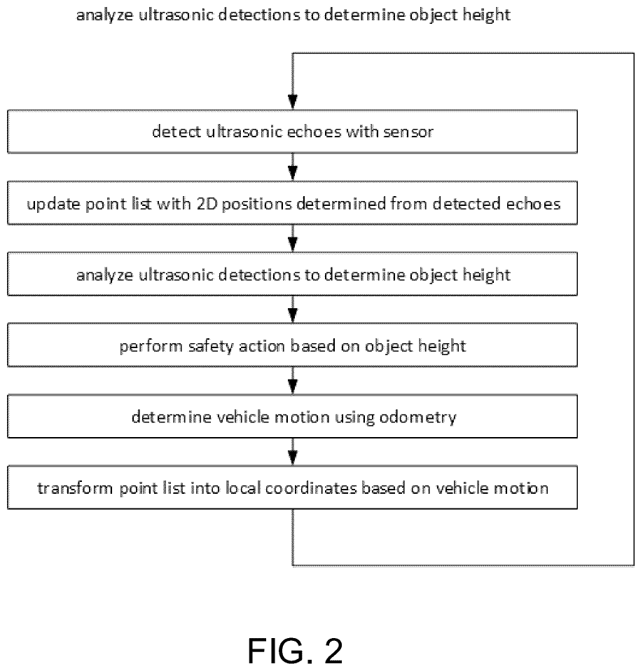

As illustrated in the flowchart of FIG. 2, the vehicle sensing system receives sensor data and detects ultrasonic echoes from the sensor data. Using the detected ultrasonic echoes, the vehicle sensing system determines a list of 2D points using triangulation. Each 2D point corresponds to a predicted position of one or more objects exterior of the equipped vehicle. Moreover, the vehicle sensing system analyzes the ultrasonic echoes to determine the height of each detected object. The determined height of each object is provided to the driver assist system, which may perform a safety action based on the determined object height, such as applying brackets of a vehicle, or notifying a driver with an alert. To maintain a list of 2D points corresponding to obstacle positions, the vehicle sensing system tracks vehicle motion using sensor data from odometry sensors, for example, measuring steering angle, velocity, acceleration, and relative changes of vehicle motion. Thereafter, the obstacle positions in the list are transformed (e.g., rotated and translated with a rigid transformation) to an updated coordinate frame of the vehicle based on tracking of the vehicle motion.

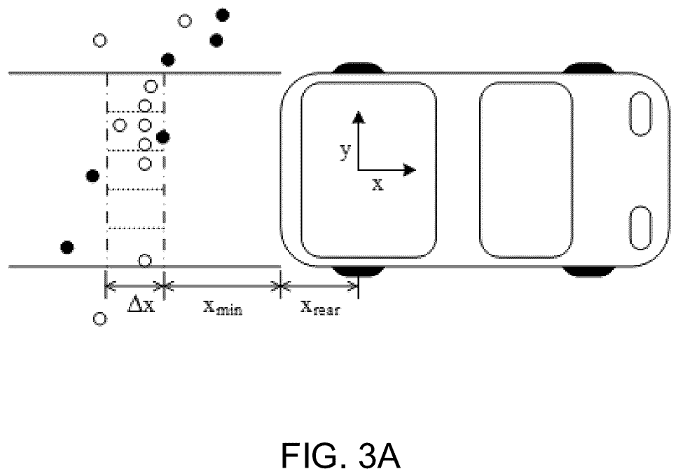

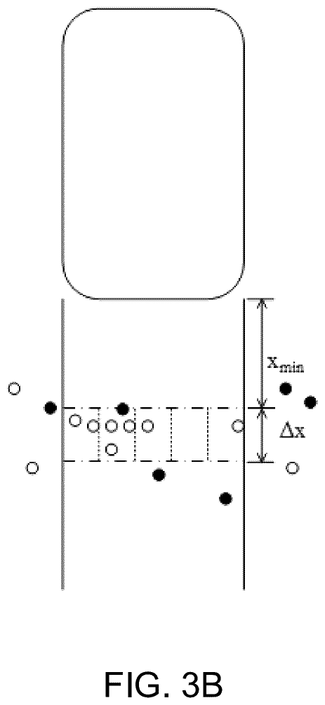

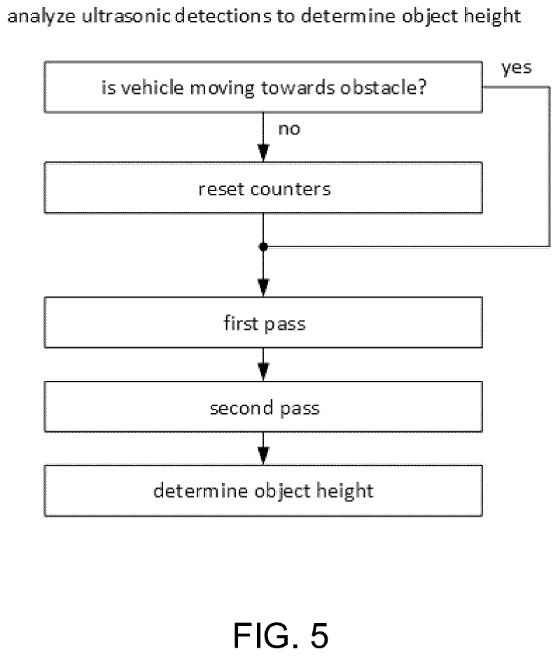

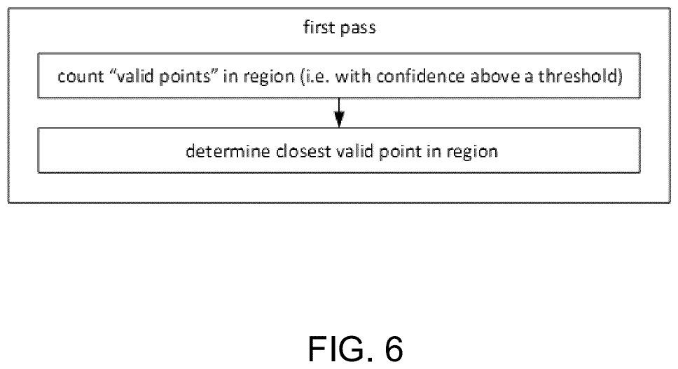

FIG. 5 illustrates an overview of the analysis process, including checking if the vehicle is moving towards an obstacle (e.g., which may trigger counter resets) before proceeding with the first and second passes to determine object height. FIG. 3A illustrates how the geometric properties of an object can be detected. For instance, the vehicle sensing system scans the list of 2D points (corresponding to obstacle positions) using a “first pass” followed by a “second pass.” Advantageously, using the two pass approach approves computational efficiency of the system. In the first pass (illustrated in FIG. 6) points with a confidence above a threshold are classified as valid, provided that the points are also within a region of interest. The region of interest may correspond to a blind spot of the vehicle or a predicted path of the vehicle. For instance, FIG. 3A depicts an example region of interest that corresponds to the area directly behind the vehicle, as shown by the solid two horizontal lines. The distance to the closest valid point (illustrated as xₘᵢₙ in FIG. 3A) is determined (relative to a rear overhang distance xᵣₑₐᵣ of the vehicle in the coordinate system as shown). In some examples, a window region is defined within the region of interest. The window region may span from a closest valid point (e.g., the closest valid point corresponds to where a potential object is located) within the region of interest for a predetermined distance. As shown in FIG. 3A, the closest valid point within the region defines a first boundary of the window region (denoted by the vertical dashed line) which extends a predetermined distance (Δ_x) to a second boundary of the window region (denoted by the other vertical dashed line). In some examples, the window region is divided into one or more bins. As shown in FIG. 3A, the window region is divided into five bins denoted by the four horizontal dashed lines within the window region.

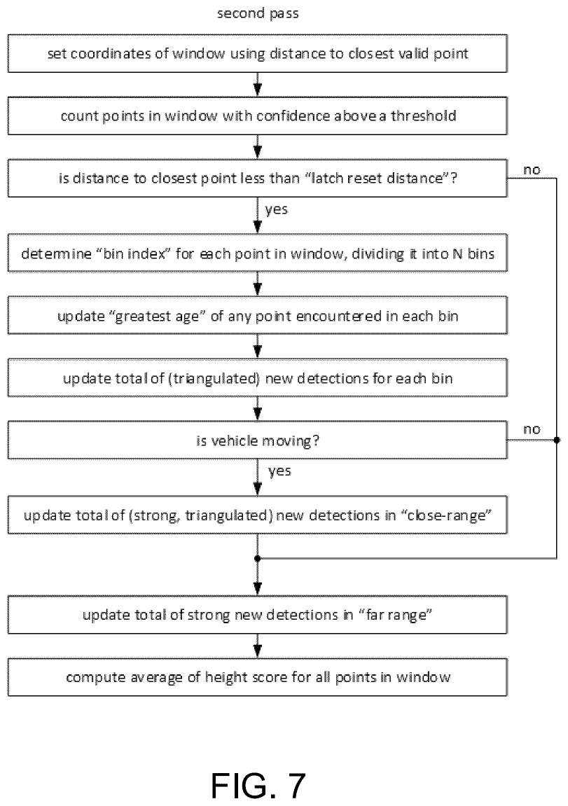

Points that fall into the window region and one of the bins are further analyzed (i.e., processed) in the second pass (as illustrated in the flowchart of FIG. 7). Determining if a detected object is wide includes determining if positions of points in the point list fill bins of the window region (e.g., determining whether points span across one or more of the bins of the window region). For example, a narrow object may only span across one of the bins, but a wide object may span across multiple of the bins or all of the bins. Coordinates of the window region are determined based on points in the point list. In particular, the nearest x-coordinate of the window is set equal to the distance of the closest valid point, which allows the window to track a detected object. The geometric size of the window may remain constant along its x-axis and y-axis.

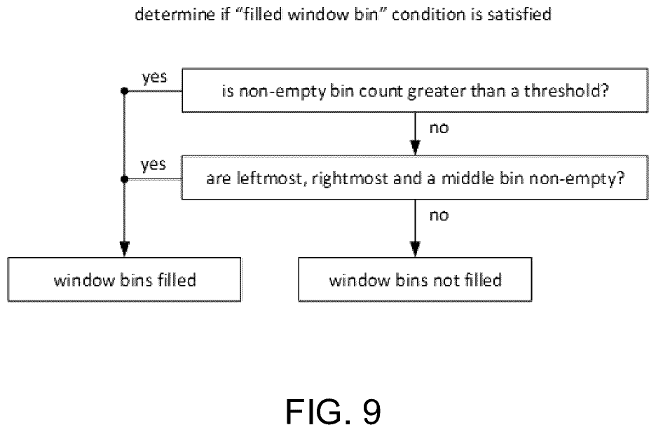

FIG. 9 is a flowchart showing steps for determining if a “filled window bin” condition is satisfied. The “window” refers to a particular dynamically positioned region surrounding the vehicle (e.g., behind the vehicle) and includes multiple “bins.” If the non-empty bin count (e.g., number of bins including at least one valid point) is greater than a bin count threshold, the filled window bin condition is satisfied. In essence, if enough window bins are filled (e.g., at least one detected 2D point is located within the bin), then a detected obstacle will be considered as wide. For example, in FIGS. 3A and 3B points are located in four of the five window bins. Thus, in the examples shown in FIGS. 3A and 3B, the filled window bin condition is satisfied if the bin count threshold is three or less. However, the window bin condition is not satisfied if the bin count threshold is four or more. In some examples, determining if a detected object is wide (e.g., satisfies a width threshold) includes determining if positions of points in the point list fill bins of a window region divided spatially into bins (FIG. 9). Here, the coordinates of the window region are determined based on points in the point list.

In some scenarios, the angular accuracy of triangulation depends on the distance of the detected objects from the sensors. With a moving vehicle, a narrow object may have a high spatial resolution (e.g., small point spread) at close distances (e.g. less than 2 m). However, at further distances, points triangulated from a narrow object might have a larger point spread due to decreased angular velocity, making the narrow object appear wider. That is, the ability to determine if an object is wide depends on the distance between the object and the sensors, which in turn depends on the motion of the vehicle towards or away from an object.

For purposes of performing a safety action in real-time, an obstacle can first become detectable before its angular extent can be resolved in high spatial resolution. Thus, the ability to determine if an object is wide and/or high varies as the vehicle approaches an obstacle. Analyzing this variation occurs as the vehicle advances and provides further information correlated with the object's height and/or its width. Relevant statistics of the distance dependent object detections are recorded and tracked in the “second pass” step (FIG. 7).

When a vehicle approaches an obstacle, a safety action such as initiating braking may be required to occur before a “brake activation distance” or threshold distance from the object is measured, a distance which at least in part depends on vehicle velocity. More specifically, the brake activation distance represents the minimum distance from an object at which the vehicle, given the current speed and available deceleration or maneuvering capabilities of the vehicle (which may be based on road conditions or environment, such as dry pavement, gravel or wet or icy road conditions, etc.), needs to initiate a safety maneuver (e.g., braking or steering) to avoid a collision or mitigate a severity of a collision. This distance may be dynamically determined as the brake activation distance is shorter at lower speeds and greater at higher speeds of the vehicle or wet or icy road conditions. The decision to apply brakes or take other action depends on the history of recorded measurements at the time when a potential obstacle reaches the brake activation distance. Notably, the vehicular sensing system may be configured to delay the final determination of whether the height of the object exceeds the height threshold, and thus the decision to maneuver the vehicle to avoid the object, until the object is at or near or approaching this brake activation distance. By waiting until the object is proximate to the brake activation distance, the system leverages the maximum available time and proximity to the object to gather and process sensor data, including detailed echo properties and the spatial distribution of 2D points associated with the object. This delayed decision point allows for the use of the most recent and potentially most accurate information regarding the characteristics of the object, such as height classification based on improved data quality available at closer ranges or over a longer observation period, thereby optimizing the decision-making process for critical safety maneuvers for a given vehicle speed.

In some implementations, the driver assist system performs a safety action based on the determined object height by applying vehicle brakes if the distance to a detected object is closer than a brake activation distance. If the object height is classified as “high”, corresponding to a potential obstacle that might collide with the host vehicle, brakes are automatically applied (a first safety action). Otherwise, if the object height is classified as “low,” and the vehicle can back over the object without collision (e.g. a curb), then the driver of the vehicle receives an alert instead (e.g., which is an alternate safety action).

In addition to, or as an alternative to, automatic vehicle maneuvering, the vehicular sensing system may employ further safety responses, such as providing tactile, visual, and/or audible alerts to the driver of the vehicle. Providing alerts to the driver may be particularly effective at greater distances from detected objects, allowing the driver more time to react or take control, and may also be suitable for objects deemed less critical or situations where automatic intervention is not immediately required. To enhance the reliability and accuracy of object classification, the vehicular sensing system may utilize a pole detector, a wall detector, and a machine learning (ML) or deep neural network (DNN) classifier. The pole detector is configured to identify objects characterized by a narrow width based on the width determination methods described herein. Similarly, the wall detector may be configured to identify objects characterized by a wide width based on the width determination. Moreover, the ML or DNN classifier is trained on recorded sensor data, including echo properties (such as echo width, strength, distance ratios), to specifically classify the height of detected objects, thereby outputting a height score or probability of being a “high” or “low” object. Notably, the dedicated pole detector and wall detector may be configured to function as safety overrides for the classifier. This override is configured to enhance the overall reliability of the system, particularly in scenarios where the classification alone may be uncertain or inaccurate. For example, because objects identified as narrow or wide may be hazardous due to their typical heights or widths, the safety override ensures that the detection of such object types by the dedicated detectors may trigger a safety response, such as an alert to the driver or automatic maneuvering, even if the classifier provides an uncertain classification or indicates a low height for that object.

In some implementations, the vehicular sensing system employs additional or alternative safety responses, such as providing visual and/or audible alerts to the driver. Notably, providing visual or audible alerts to the driver may be particularly effective at greater distances from detected objects. For example, the vehicular sensing system may include a dedicated pole detector (configured to identify narrow objects based on width determination), a wall detector (configured to identify wide objects based on width determination), and a machine learning (ML) or deep neural network (DNN) classifier. The ML or DNN classifier may be trained based on recorded data specifically to classify object height. Here, the pole detector and wall detector may be configured to act as ‘safety overrides’ to enhance the reliability of the DNN classifier when acting alone, for instance, ensuring that certain object types known to be hazardous (e.g., poles or walls) trigger an alert even if the DNN classification is uncertain or indicates a low height.

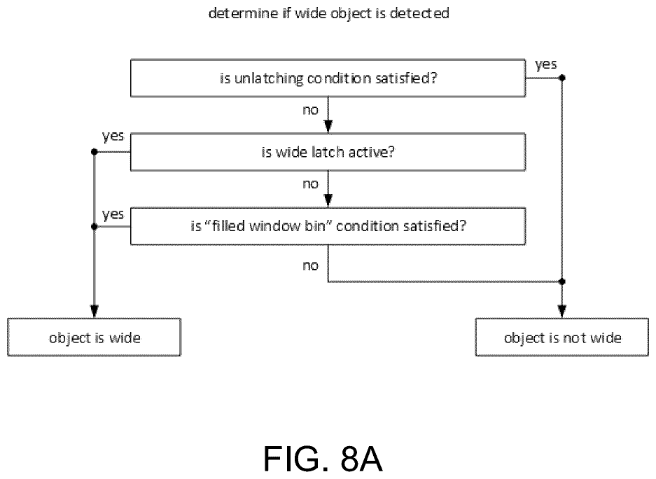

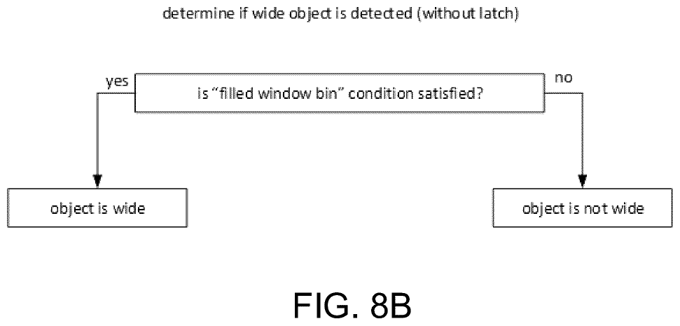

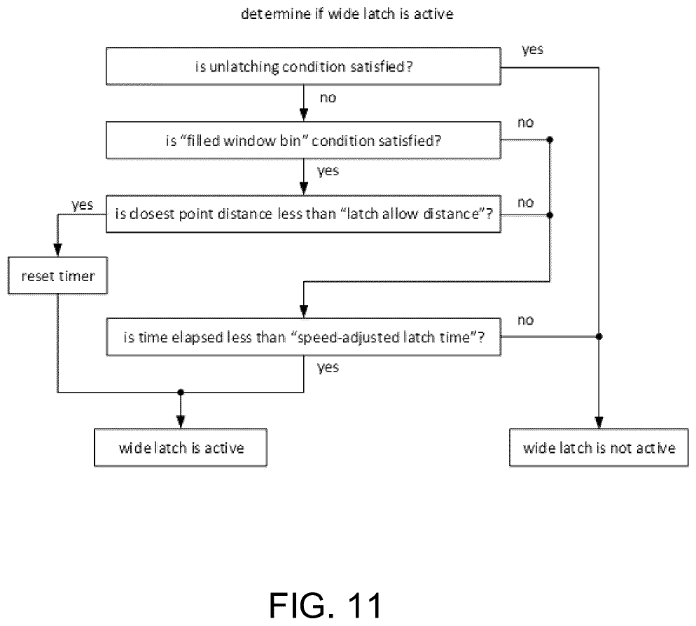

Estimates of an object's width or its height classification may change as the host vehicle approaches. To keep track of the estimated object width in real-time, a “latch” is applied when recorded measurements indicate a wide object has been detected. That is, the latch is used to maintain and/or hold a state as new measurements arrive, which is important because accuracy of wide object detection varies with object approach distance and sensor field-of-view is distance dependent. In some examples, determining if a detected object is “wide” includes determining if a latch is active (illustrated in flowcharts of FIGS. 8A and 11). The latch may remain active for a duration following an initial determination that a wide object is detected, which may be adjusted based on speed (FIG. 11). FIG. 8B shows a simplified determination of whether an object is wide based solely on the “filled window bin” condition, without considering latching logic.

When moving towards an object that has been latched as wide, the history of recorded measurements (including new measurements) may reveal the object is unlikely to be wide (e.g., the point distributions consistently narrows as the vehicle gets closer). In this case, analysis of measurement statistics is used to reset (inactivate) the wide latch, as shown in FIG. 8A. In some examples, resetting the latch only occurs when the distance to the closest point associated with the object is less than a “latch reset distance”.

The history of recorded measurements for tracking objects is retained (at least in part) by storing a list of triangulated positions (e.g., 2D points) associated with each tracked object. These points are continually updated to reflect their position in the current local vehicle coordinate frame by performing tracking with odometry as the vehicle moves (as described above).

In the flowchart illustrated in FIG. 7, statistics are tracked for points (triangulated positions) encountered within a window region divided into N bins. This includes counting the number of points in the window with confidence above a threshold (i.e. points that are considered too weak are below the threshold). When the point confidence is above a threshold, it is considered “strong.” A “bin index” for each point in the window region is determined which corresponds to the window subdivision where a point is located (illustrated in FIGS. 3A and 3B). Counters are reset when the host vehicle is not approaching an object. For example, counters are reset if the vehicle gear is not in reverse, and thus, not backing towards an obstacle. In each bin, the greatest age of any point encountered (since the counters were reset) is recorded. The age of points indicates if redetections continue to occur, signifying how long an obstacle has been within the field of view. The total of new detections (including redetections and first detections) in each bin is also counted. This indicates how many echoes occur within a spatial region. When the vehicle is in motion, the number of new strong “close-range” detections are recorded. Certain low objects cannot be detected at close range (e.g. under 1 m), so this indicates the presence of high objects. The total of new objects at “far range” (e.g. 2 m to 3 m) is also counted, indicating strength of detection at this distance. As well, the average height score of points within the window region is computed.

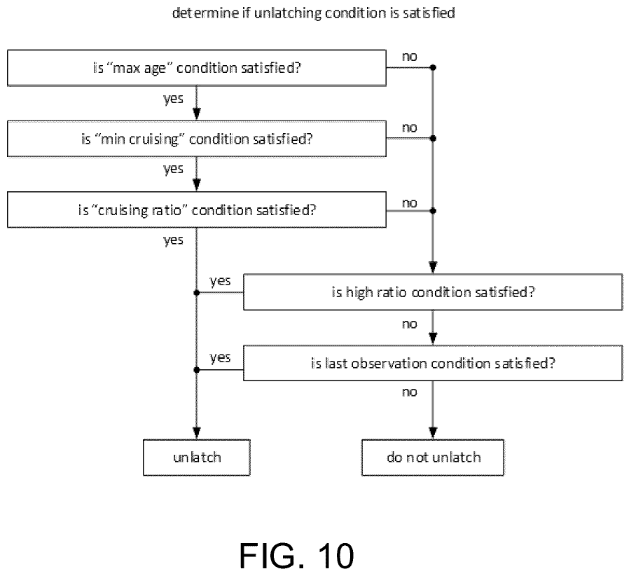

In some implementations, as shown in FIG. 10, a latch used to maintain the state for a wide object is reset if certain conditions are true. First, a “maximum age condition” is evaluated, which is true if the maximum age of any point in the point list within the window region exceeds an age threshold. The latch is also reset by evaluating a “minimum cruising” condition, which is true if the maximum elapsed time since detection of any point in the point list within a window region exceeds a time threshold. As well, the latch may be reset by a “cruising ratio” condition, which is evaluated as true if the ratio of maximum elapsed time since detection to average elapsed time since detection of any point in the point list within a window region exceeds a threshold. Likewise, a “high ratio” condition is evaluated, whereby a ratio of maximum elapsed time since detection to average elapsed time since detection of any point in the point list within any bin exceeds a threshold. Lastly, a “last observation” condition, which resets the latch, is evaluated as true if a count of close-range detections exceeds a threshold. Other latch reset conditions are also possible.

As described above, the vehicular sensing system processes sensor data received from one or more sensors to determine a height classification or estimate of each object exterior of the equipped vehicle. That is, the vehicular sensing system determines a list of 2D points, with each 2D point corresponding to a respective location on an object exterior of the equipped vehicle. Thus, a single object may be associated with multiple 2D points from the list of 2D points and the list of 2D points may represent multiple locations on multiple objects. When the vehicle sensing system determines a particular object is in a predicted path of travel of the vehicle and the height of the particular object exceeds a height threshold, the vehicle sensing system may instruct the vehicle to maneuver to avoid the object. The vehicle sensing system may determine whether the object is within the path of travel of the equipped vehicle based on movement (i.e., velocity and steering angle) of the equipped vehicle relative to the object. For example, the vehicle sensing system may determine that another vehicle is in the predicted path of the vehicle and maneuver the vehicle to avoid colliding with the other vehicle. On the other hand, when the vehicle sensing system determines a particular object is within the predicted path of the vehicle and its determined height fails to exceed the height threshold, the vehicle sensing system may generate a notification altering a driver of the vehicle of the particular object without maneuvering the vehicle to avoid the particular object. For example, a pothole or a small bump may be within the predicted path of the vehicle, and in such cases the vehicle sensing system may simply alert the driver of the pothole or the small bump rather than maneuvering the vehicle to avoid the object.

In some examples, the vehicle sensing system determines that the height of an object exceeds the height threshold indirectly, by determining a width of the object based on the sensor data and determining that the width of the object is less than a width threshold. That is, in some scenarios, it is difficult for the vehicle sensing system to accurately predict the height of objects with narrow widths, such as a telephone pole. Thus, the vehicle sensing system may first determine the width of an object based on the sensor data. If the width of the object is less than the width threshold, the vehicle sensing system infers that any predicted height of the object may be inaccurate and assumes that the height of the object exceeds the height threshold (as shown in FIGS. 4A and 4B). Notably, the vehicle sensing system makes this assumption without actually predicting the height of the object. Instead, the vehicle sensing system assumes the height of the object exceeds the height threshold based on the width of the object being less than the width threshold. If the width of the object is greater than the width threshold, the vehicle sensing system infers it may accurately or more reliably predict the height of the object using echo property analysis. Thus, based on determining the width of an object is greater than the width threshold, the vehicle sensing system predicts the height of the object based on the sensor data and determines whether the predicted height of the object is greater than the height threshold.

In some examples, the vehicular sensing system latches or locks or holds or maintains the determined width of the object responsive to determining the width of the object exceeds the width threshold. Here, latching the determined width of the object sets or maintains the determined width of the object for the predetermined amount of time irrespective of new captured sensor data that is captured during the time period that elapses at the end of the predetermined amount of time. As such, latching the width of the object prevents the vehicular sensing system from rapidly oscillating between classifications, e.g., determining that the width of the object exceeds the width threshold, and then (within the predetermined amount of time) determining that the width of the object no longer exceeds the width threshold based on newly captured sensor data which may be temporarily noisy or less accurate. To that end, when determining whether the width of the object exceeds the width threshold, the vehicular sensing system may determine whether the width of the object is currently latched as wide.

In some implementations, the vehicle sensing system determines the height of each object using a two pass approach. During the first pass, the vehicle sensing system identifies 2D points from the list of 2D points within a region of interest (e.g., valid 2D points). The region of interest may correspond to an area behind the vehicle when the vehicle is operating in a rearward direction or an area in front of or adjacent to the vehicle when the vehicle is operating in a forward direction. The identified 2D points within the region of interest are processed during the second pass while 2D points outside of the region of interest are discarded from this particular analysis.

During the second pass, the vehicle sensing system identifies the 2D point that is closest to the vehicle within the region of interest and defines the window region based on the closest 2D point. As shown in FIGS. 3A and 3B, the closest 2D point is a distance of Xₘᵢₙ behind the vehicle which establishes a first boundary of the window region that extends a predetermined distance Δₓ from the first boundary to a second boundary. The area within the region of interest between the first boundary and the second boundary defines the window region. The window region may be divided into one or more window bins. Here, the vehicle sensing system determines whether an object satisfies the width threshold based on whether the object spans across a predetermined number of the window bins. That is, multiple 2D points from the list may correspond to a single object. Thus, determining whether the 2D points that correspond to the single object span across the predetermined number of bins indicates to the vehicle sensing system that the object exceeds the width threshold, otherwise the object does not exceed the width threshold. Put another way, the vehicle sensing system determines whether the 2D points associated with an object span across the predetermined number of window bins to determine whether the object exceeds the width threshold.

Thus, the vehicular sensing system classifies the height of detected external objects to differentiate hazardous objects from non-hazardous low-profile objects, particularly when faced with limitations inherent in certain sensor geometries such as coplanar ultrasonic sensor arrays where height determination via triangulation alone is ambiguous. The vehicular sensing system integrates two distinct analysis domains. First, the analysis of intrinsic echo properties derived from received ultrasonic signals (e.g., echo width, strength, distance ratios, potentially yielding a height score). Second, the analysis of the geometric, spatial distribution of the 2D points triangulated from these echoes over time. This synergistic combination allows the system to leverage the strengths of both approaches for a more reliable height assessment.

Moreover, the vehicular sensing system initially assesses the width of an object, determined by analyzing the spread of associated 2D points, for instance, using a dynamic window-and-bin technique relative to the closest detected point. A subset of the 2D points associated with the object is tracked or monitored as the vehicle moves relative to the object to determine change in the spatial distribution of the subset of associated 2D points and to determine or estimate width of the object based on the determined change in spatial distribution of the subset of associated 2D points. If an object is determined to be narrow (e.g., having a width less than or below the width threshold), the object is conservatively classified as high due to potential height ambiguity in echo property analysis for such geometries. Conversely, if deemed wide (e.g., having a width equal to or greater than the width threshold), the height classification of the object relies primarily on the analysis of echo properties (e.g., the computed height score). This differentiated strategy, augmented by the tracking of point statistics (e.g., age, confidence, and detection counts within bins) and the potential utilization of a latching mechanism to maintain stable width assessments despite varying sensor accuracy with distance, provides a more reliable and context-aware height classification than previously possible, enabling more appropriate downstream safety actions by a driver assistance system.

The sensor (e.g., the sensor that senses the object or the sensor that is used to determine path of travel of the vehicle, such as by determining lane markers along the road ahead of the vehicle, and/or the sensor that is used to determine location of the object relative to the vehicle or path of travel of the vehicle) may comprise any suitable camera or sensor. Optionally, the camera may comprise a “smart camera” that includes an imaging sensor array and associated circuitry and image processing circuitry and electrical connectors and the like as part of a camera module, such as by utilizing aspects of the systems described in U.S. Pat. Nos. 10,099,614 and/or 10,071,687, which are hereby incorporated herein by reference in their entireties.

The system may include an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The imaging sensor of the camera may capture image data for image processing and may comprise, for example, a two-dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The imaging device and control and image processor and any associated illumination source, if applicable, may comprise any suitable components, and may utilize aspects of the cameras (such as various imaging sensors or imaging array sensors or cameras or the like, such as a CMOS imaging array sensor, a CCD sensor or other sensors or the like) and systems described in U.S. Pat. Nos. 5,760,962; 5,715,093; 6,922,292; 6,757,109; 6,717,610; 6,590,719; 6,201,642; 5,796,094; 6,559,435; 6,831,261; 6,822,563; 6,946,978; 7,720,580; 8,542,451; 7,965,336; 7,480,149; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454 and/or 6,824,281, and/or International Publication Nos. WO 2009/036176; WO 2009/046268; WO 2010/099416; WO 2011/028686 and/or WO 2013/016409, and/or U.S. Publication Nos. US 2010-0020170 and/or US-2009-0244361, which are all hereby incorporated herein by reference in their entireties.

Optionally, the camera may comprise a forward viewing camera, such as disposed at a windshield electronics module (WEM) or the like that is at an in-cabin side of the windshield of the vehicle. The forward viewing camera may utilize aspects of the systems described in U.S. Pat. Nos. 9,896,039; 9,871,971; 9,596,387; 9,487,159; 8,256,821; 7,480,149; 6,824,281 and/or 6,690,268, and/or U.S. Publication Nos. US-2020-0039447; US-2015-0327398; US-2015-0015713; US-2014-0160284; US-2014-0226012 and/or US-2009-0295181, which are all hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controls at least one function or feature of the vehicle (such as to provide autonomous driving control of the vehicle) responsive to processing of the data captured by the radar sensors.

The ECU may be operable to process data for at least one driving assist system of the vehicle. For example, the ECU may be operable to process data (such as radar data captured by a radar sensor and/or image data captured by a forward-viewing camera of the vehicle that views forward of the vehicle through the windshield of the vehicle) for at least one selected from the group consisting of (i) a headlamp control system of the vehicle, (ii) a pedestrian detection system of the vehicle, (iii) a traffic sign recognition system of the vehicle, (iv) a collision avoidance system of the vehicle, (v) an emergency braking system of the vehicle, (vi) a lane departure warning system of the vehicle, (vii) a lane keep assist system of the vehicle, (viii) a blind spot monitoring system of the vehicle and (ix) an adaptive cruise control system of the vehicle. Optionally, the ECU may also or otherwise process other data captured by other sensors of the vehicle (such as other cameras or radar sensors or such as one or more lidar sensors of the vehicle). Optionally, the ECU may process captured data for an autonomous control system of the vehicle that controls steering and/or braking and/or accelerating of the vehicle as the vehicle travels along the road.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. Nos. 10,442,360 and/or 10,046,706, and/or U.S. Publication Nos. US-2021-0245662; US-2021-0162926; US-2021-0155167 and/or US-2019-0118717, and/or International Publication No. WO 2022/150826, which are all hereby incorporated herein by reference in their entireties.

Optionally, the system may include a display for displaying images captured by one or more of the imaging sensors for viewing by the driver of the vehicle while the driver is normally operating the vehicle. Optionally, for example, the system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties.

Optionally, the system (utilizing the forward viewing camera and a rearward viewing camera and other cameras disposed at the vehicle with exterior fields of view) may be part of or may provide a display of a top-down view or bird's-eye view system of the vehicle or a surround view at the vehicle, such as by utilizing aspects of the systems described in U.S. Pat. Nos. 10,071,687; 9,900,522; 9,834,153; 9,762,880; 9,596,387; 9,264,672; 9,126,525 and/or 9,041,806, and/or U.S. Publication No. US-2015-0022664, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular sensing system, the vehicular sensing system comprising:
a sensor disposed at a vehicle equipped with the vehicular sensing system, wherein the sensor senses exterior of the equipped vehicle, and wherein the sensor is operable to capture sensor data;
an electronic control unit (ECU) comprising electronic circuitry and associated software;
wherein the electronic circuitry of the ECU comprises a data processor operable to process the sensor data captured by the sensor and transferred to the ECU;
wherein, with the vehicle moving relative to an object exterior of the equipped vehicle, the vehicular sensing system, via processing at the ECU of sensor data captured by the sensor, determines two-dimensional (2D) points associated with the object, and wherein each 2D point corresponds to a respective location on the object;
wherein the vehicular sensing system determines width of the object based at least in part on a spatial distribution of a subset of the 2D points associated with the object as the vehicle moves relative to the object;
wherein the vehicular sensing system determines height of the object based at least in part on (i) 2D points associated with the object and (ii) the determined width of the object;
wherein the vehicular sensing system, based at least in part on movement of the equipped vehicle relative to the object, determines whether the object is within a path of travel of the equipped vehicle; and
wherein, responsive to (i) the object being within the path of travel of the equipped vehicle and (ii) the determined height of the object exceeding a height threshold, the equipped vehicle is maneuvered to avoid the object.

2. The vehicular sensing system of claim 1, wherein the vehicular sensing system, via information data pertaining to movement of the equipped vehicle, determines whether another object is within the path of travel of the equipped vehicle and, responsive to determining that the other object is within the path of travel and height of the other object fails to satisfy the height threshold, generates a notification alerting a driver of the equipped vehicle of the other object.

3. The vehicular sensing system of claim 1, wherein the sensor comprises an ultrasonic sensor.

4. The vehicular sensing system of claim 1, wherein the sensor comprises a radar sensor.

5. The vehicular sensing system of claim 1, wherein the sensor comprises an image sensor.

6. The vehicular sensing system of claim 5, wherein the path of travel of the equipped vehicle is determined at least in part via processing of image data captured by image sensor.

7. The vehicular sensing system of claim 1, wherein the sensor comprises a lidar sensor.

8. The vehicular sensing system of claim 1, wherein determining that the height of the object exceeds the height threshold is based on the determined width being less than a width threshold.

9. The vehicular sensing system of claim 1, wherein the vehicular sensing system, via processing the sensor data, determines the width of the object by (i) defining a window region based on a closest 2D point within a region of interest to the equipped vehicle, the window region comprising one or more window bins, and (ii) determining whether the 2D points associated with the object span across a predetermined number of the window bins.

10. The vehicular sensing system of claim 9, wherein the vehicular sensing system, responsive to determining that the 2D points associated with the object span across the predetermined number of the window bins, determines that the determined width of the object exceeds a width threshold.

11. The vehicular sensing system of claim 9, wherein the vehicular sensing system, responsive to determining that the 2D points associated with the object does not span across the predetermined number of the window bins, determines that the width of the object is less than a width threshold.

12. The vehicular sensing system of claim 1, wherein movement of the equipped vehicle relative to the object is determined via at least one selected from the group consisting of (i) a steering angle of the equipped vehicle, (ii) a velocity of the equipped vehicle and (iii) an acceleration of the equipped vehicle.

13. The vehicular sensing system of claim 1, wherein the vehicular sensing system, responsive to the determined width of the object exceeding a width threshold, maintains the determined width of the object for a predetermined amount of time irrespective of new sensor data captured by the sensor during the predetermined amount of time.

14. The vehicular sensing system of claim 13, wherein determining that the width of the object exceeds the width threshold comprises determining whether the determined width of the object is currently being maintained for the predetermined amount of time.

15. The vehicular sensing system of claim 13, wherein the vehicular sensing system, responsive to determining an elapsed time since determining any 2D point from the 2D points exceeds an age threshold, resets the maintained determined width of the object.

16. The vehicular sensing system of claim 1, wherein maneuvering to avoid the object occurs responsive to determining that distance between the equipped vehicle and the object is equal to a threshold braking distance, and wherein the threshold braking distance comprises a determined minimum distance that the equipped vehicle needs to avoid colliding with the object.

17. The vehicular sensing system of claim 16, wherein the determined minimum distance is determined based at least in part on at least one selected from the group consisting of (i) speed of the equipped vehicle and (ii) a road condition of a road along which the equipped vehicle is traveled.

18. The vehicular sensing system of claim 1, wherein the sensor senses at least forward of the vehicle, and wherein the vehicular sensing system determines whether the detected object is within a path of forward travel of the equipped vehicle.

19. The vehicular sensing system of claim 1, wherein the sensor senses at least rearward of the vehicle, and wherein the vehicular sensing system determines whether the detected object is within a path of rearward travel of the equipped vehicle.

20. A vehicular sensing system, the vehicular sensing system comprising:
an ultrasonic sensor disposed at a vehicle equipped with the vehicular sensing system, wherein the ultrasonic sensor senses exterior of the equipped vehicle, and wherein the ultrasonic sensor is operable to capture sensor data;
an electronic control unit (ECU) comprising electronic circuitry and associated software;
wherein the electronic circuitry of the ECU comprises a data processor operable to process the sensor data captured by the ultrasonic sensor and transferred to the ECU;
wherein, with the vehicle moving relative to an object exterior of the equipped vehicle, the vehicular sensing system, via processing at the ECU of sensor data captured by the ultrasonic sensor, determines two-dimensional (2D) points associated with the object, and wherein each 2D point corresponds to a respective location on the object;
wherein the vehicular sensing system determines width of the object based at least in part on a spatial distribution of a subset of the 2D points associated with the object as the vehicle moves relative to the object;
wherein the vehicular sensing system determines height of the object based at least in part on (i) 2D points associated with the object and (ii) the determined width of the object;
wherein the vehicular sensing system, based at least in part on movement of the equipped vehicle relative to the object, determines whether the object is within a path of travel of the equipped vehicle; and
wherein, responsive to (i) the object being within the path of travel of the equipped vehicle and (ii) determining that the determined height of the object exceeds a height threshold based on the determined width being less than a width threshold, the equipped vehicle is maneuvered to avoid the object.

21. The vehicular sensing system of claim 20, wherein maneuvering to avoid the object occurs responsive to determining that distance between the equipped vehicle and the object is equal to a threshold braking distance, and wherein the threshold braking distance comprises a determined minimum distance that the equipped vehicle needs to avoid colliding with the object.

22. The vehicular sensing system of claim 20, wherein the vehicular sensing system, via processing the sensor data, determines the width of the object by (i) defining a window region based on a closest 2D point within a region of interest to the equipped vehicle, the window region comprising one or more window bins, and (ii) determining whether the 2D points associated with the object span across a predetermined number of the window bins.

23. A vehicular sensing system, the vehicular sensing system comprising:
a sensor disposed at a vehicle equipped with the vehicular sensing system, wherein the sensor senses exterior of the equipped vehicle, and wherein the sensor is operable to capture sensor data;
an electronic control unit (ECU) comprising electronic circuitry and associated software;
wherein the electronic circuitry of the ECU comprises a data processor operable to process the sensor data captured by the sensor and transferred to the ECU;
wherein, with the vehicle moving relative to an object exterior of the equipped vehicle, the vehicular sensing system, via processing at the ECU of sensor data captured by the sensor, determines two-dimensional (2D) points associated with the object, and wherein each 2D point corresponds to a respective location on the object;
wherein the vehicular sensing system determines width of the object based at least in part on a spatial distribution of a subset of the 2D points associated with the object as the vehicle moves relative to the object;
wherein the vehicular sensing system, via processing the sensor data, determines the width of the object by (i) defining a window region based on a closest 2D point within a region of interest to the equipped vehicle, the window region comprising one or more window bins, and (ii) determining whether the 2D points associated with the object span across a predetermined number of the window bins;
wherein the vehicular sensing system, responsive to determining that the 2D points associated with the object span across a predetermined number of the window bins, determines that the determined width of the object exceeds a width threshold;
wherein the vehicular sensing system, responsive to determining that the determined width of the object exceeds the width threshold, maintains the determined width of the object for a predetermined amount of time irrespective of new sensor data captured by the sensor during the predetermined amount of time;
wherein the vehicular sensing system determines height of the object based at least in part on (i) 2D points associated with the object and (ii) the determined width of the object;
wherein the vehicular sensing system, based at least in part on movement of the equipped vehicle relative to the object, determines whether the object is within a path of travel of the equipped vehicle; and
wherein, responsive to (i) the object being within the path of travel of the equipped vehicle and (ii) the determined height of the object exceeding a height threshold, the equipped vehicle is maneuvered to avoid the object.

24. The vehicular sensing system of claim 23, wherein determining that the height of the object exceeds the height threshold is based on the determined width being less than a width threshold.

25. The vehicular sensing system of claim 23, wherein maneuvering to avoid the object occurs responsive to determining that distance between the equipped vehicle and the object is equal to a threshold braking distance, and wherein the threshold braking distance comprises a determined minimum distance that the equipped vehicle needs to avoid colliding with the object.
